(19) United States
(12) Patent Application Publication
(10) Pub. No.: US 2004/0128412 A1
(43) Pub. Date: Jul. 1, 2004

(54) Remoting peripheral devices

(76) Inventor: Edward R. Harrison, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/330,870

(22) Filed: Dec. 27, 2002

(51) Int. Cl. G06F 13/00

(52) U.S. Cl. 710/33

(57) ABSTRACT

A method is described for supporting the access of a remotely located peripheral device in the area of remoting technology. Generally, data is transmitted from a remotely located peripheral device to a host PC (personal computer) via a device adaptor box associated with the remotely located peripheral device, and a PC adaptor box associated with the host PC. Data from a peripheral device is converted from a standard interface to a network stream, and transmitted over a network to the PC adaptor box. At the PC adaptor box, the data is converted back to a standard interface, where it is used by the remotely located peripheral device's device driver and virtual control module.

### COPYRIGHT NOTICE

A portion of the disclosure of this patent document may contain material which is subject to copyright protection. To the extent that it does, the copyright owner has no objection to the facsimile reproduction by anyone of the patent document or the patent disclosure as it appears in the Patent and Trademark Office patent file or records, but otherwise reserves all copyright rights whatsoever. The following notice applies to any software and data that may be described below and in the drawings hereto: Copyright© 2002, Intel Corporation, All Rights Reserved.

### FIELD

Embodiments of this invention relate to the field of remoting technology, and more particularly, to a system for providing access to remotely located peripheral devices for remoting technology.

### BACKGROUND

Remoting technology refers to technology that allows users to access applications on a personal computer from remote devices. For example, as of the filing of this application, Microsoft® will soon release a product that will remote Microsoft® Windows® XP applications onto a variety of devices. Using this device, the user may access any application, information, and service available from the user's personal computer.

While the user may access personal computer applications, information, and services from the remote device, the ability for the user to access peripheral devices that are traditionally associated with a personal computer is currently limited to a mouse and keyboard by software called RDP (Remote Desktop Protocol). On the remote device side, client mouse and keyboard messages are redirected from the remote device to the host PC using RDP protocol. On the host PC side, RDP uses its own virtual keyboard and mouse driver to receive keyboard and mouse events using RDP protocol.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating a system for remoting technology within general embodiments of the invention.

FIG. 2 illustrates a host PC for use within general embodiments of the invention.

FIG. 3 is a block diagram illustrating adaptor boxes within general embodiments of the invention.

FIG. 4 is a block diagram illustrating a device adaptor box within general embodiments of the invention.

FIG. 5 is a block diagram illustrating a PC adaptor box within general embodiments of the invention.

FIG. 6 is a flowchart illustrating a method for transmitting data to and from a remotely located peripheral device within general embodiments of the invention.

FIG. 7 is a block diagram illustrating a first exemplary embodiment of the invention.

FIG. 8 is a block diagram illustrating a second exemplary embodiment of the invention.

FIG. 9 is a block diagram illustrating a third exemplary embodiment of the invention.

### DETAILED DESCRIPTION

In one aspect of embodiments of the invention is a method for facilitating access to remotely located peripheral devices in the area of remoting technology. The method comprises receiving a request from a remote device to use a remotely located peripheral device, transmitting the request to a device adaptor box associated with the remote device, translating the request to a network stream on the device adaptor box, sending the network stream over a network, receiving the network stream on a PC adaptor box associated with a host PC (personal computer), and translating the network stream into a standard peripheral interface for use by the host PC.

Embodiments of the present invention include various operations, which will be described below. The operations associated with embodiments of the present invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software.

Embodiments of the present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/machine-readable medium suitable for storing electronic instructions.

Moreover, embodiments of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

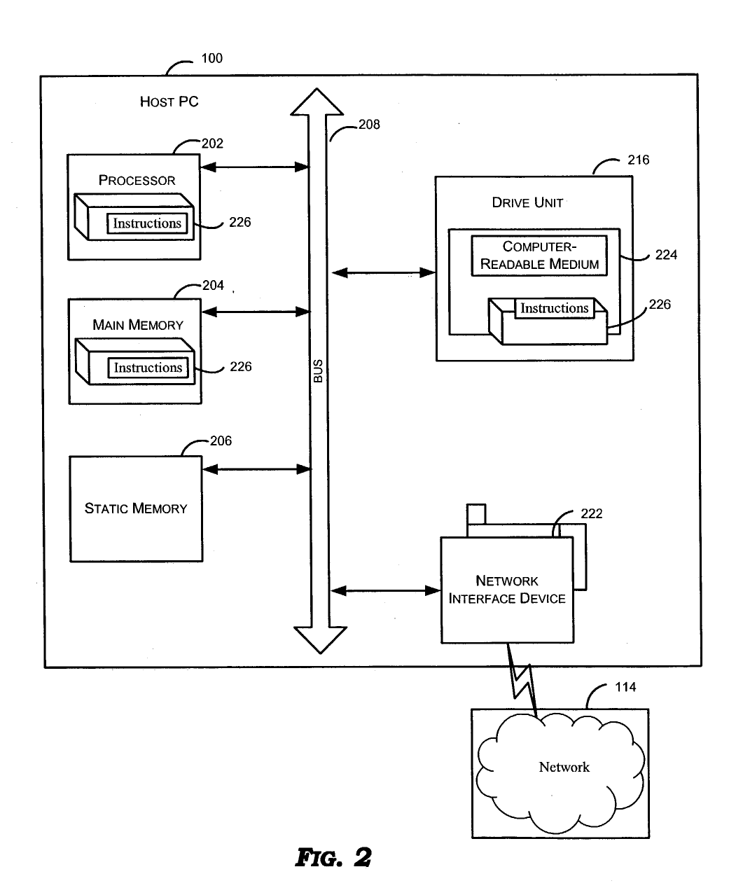

For the purposes of the present specification, the term “machine-readable medium” shall be taken to include any medium that is capable of storing or encoding a sequence of instructions for execution by a machine, such as the computer system of FIG. 2 (to be described below), and that causes the machine to perform the methods in accordance with embodiments of the present invention. The term “machine-readable medium” shall be taken to include, but not be limited to, solid-state memories, optical and magnetic disks, and carrier wave signals.

Introduction

Remoting technology allows users to interact with a personal computer hosting a remote session (hereinafter referred to as a “host PC”) from various remote devices. For example, a user may access applications that exist on a host PC (hereinafter referred to as “desktop applications”) from remote devices located in various places of a local area network, such as a home. Typically, the locations will be at some distance from the host PC.

Users who access desktop applications typically need access to peripheral devices as well. For example, a user may need access to a CD-ROM (Compact Disc-Read Only Memory) drive for playing audio CDs, games, or installing software; a disk drive such as a floppy, ZIP, or other removable storage for archiving or accessing stored data; PDA (Personal Digital Assistant) for calendar synchronization; and a digital camera for downloading digital images from a Compact Flash or a Memory Stick. Of course, this list is not exhaustive.

Since remoting technology allows a user to be physically separated from a host PC while utilizing the desktop applications, the user does not have convenient access to peripheral devices traditionally associated with a PC. From the user's perspective, it is a significant inconvenience to walk to a peripheral device attached to a host PC when the user is at a remote device.

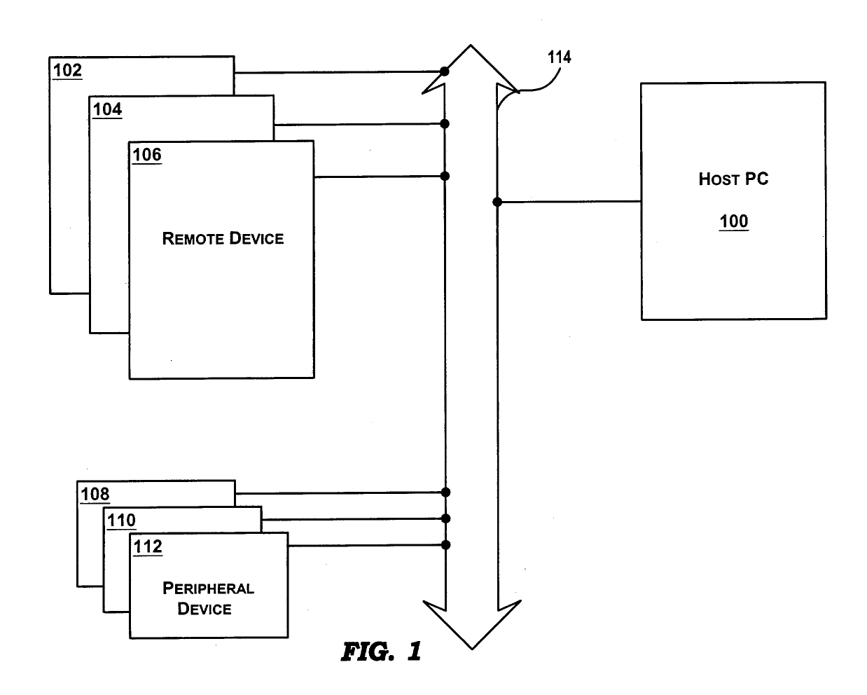

Embodiments of the invention allow users to have peripheral devices co-located with a remote device. In other words, a peripheral device may be physically attached to a remote device, but remote from the host PC, or at a location remote from both the remote device and the host PC. In reference to FIG. 1, at least one remote device 102, 104, 106 is connected to a host PC 100 via a network connection 114. Furthermore, one or more peripheral devices 108, 110, 112 may be communicatively coupled to a remote device 102, 104, 106. The peripheral devices 108, 110, 112 may be directly connected to remote device 102, 104, 106 , or may communicate using the network 114. Connectivity between the host PC 100 and a remote device 102, 104, 106, as well as between a remote device 102, 104, 106 and a peripheral device 108, 110, 112 may be through a wired and/or a wireless network.

From the perspective of the PC, the peripheral devices will appear to be directly connected, using standard interfaces (i.e., PCI (Peripheral Component Interconnect), USB (Universal Serial Bus)) when, in fact, the peripheral devices are connected via a network (wired or wireless). For the user, this means that peripheral devices can be installed in locations remote from the host PC.

While currently known implementations of embodiments of the invention use the Microsoft® Windows® XP platform, and some of the terms used herein may be specific to the Microsoft® Windows® XP platform, one of ordinary skill in the art would understand that embodiments of the invention are not limited to the platforms described herein, and that other platforms are contemplated without departing from the broad spirit and scope of the invention.

Terminology

Throughout the description, the following terms are used, and are generally defined, except as otherwise noted.

Host PC

A host PC 100 refers to a personal computer which hosts a remote session, and which has desktop applications. The host PC runs on an operating system that supports remoting technology, such as Microsoft® Windows® XP.

FIG. 2 is a diagrammatic representation of a machine in the form of host PC 100 within which software, in the form of a series of machine-readable instructions exists. The host PC 100 includes a processor 202, a main memory 204 and a static memory 206, which communicate via a bus 208.

The host PC 100 may also include a disk drive unit 216 and a network interface device 222. The disk drive unit 216 accommodates a machine-readable medium 224 on which software 226 is stored. The software 226 is shown to also reside, completely or at least partially, within the main memory 204 and/or within the processor 202. The network interface device 222 enables the host PC 100 to communicate with a network 114.

Remote Session

A remote session refers to an executable application on the host PC 100 that enables the host PC 100 and corresponding remote devices 102, 104, 106 to communicate via a remoting protocol, such as RDP.

Desktop Applications

Desktop applications refer to applications, information, or services available from a host PC 100. Desktop applications may include, for example, Microsoft® Windows® Office applications, financial software applications, Microsoft® Windows® Explorer, files, directories, and the Internet. If all applications on the desktop are available to a remote device, then the entire desktop is said to be remoted. It is also contemplated that only a subset of the desktop applications may be remoted as well.

Remote Device

A remote device 102, 104, 106 refers to a device that enables a user to access desktop applications from a location that is remote from a host PC 100. A remote device 102, 104, 106 is connected to the host PC 100 via a network 114. In described embodiments of the invention, a remote device 102, 104, 106 is connected to the host PC 100 through an 802.11b wireless connection. One or more remote devices 102, 104, 106 may be networked to a host PC 100.

A remote device 102, 104, 106 may comprise a mobile monitor, a home kiosk, or a remoting-enabled TV. A mobile monitor is a wireless, mobile, battery operated tablet with a touchscreen designed for maximum portability. A home kiosk is a fixed-location, AC powered device with a monitor, a keyboard, and a mouse that are not intended to be moved around during use. A remoting-enabled TV merges a television with the ability to display desktop applications.

Peripheral Device

A peripheral device 108, 110, 112 refers to a device that is not part of the computer. A peripheral device 108, 110, 112 may be external, such as, for example, a mouse, keyboard, printer, monitor, external ZIP drive, or scanner; or internal, such as, for example, CD-ROM (Compact Disk-Read Only Memory) drive, CD-R drive (Compact Disc-Recordable), or an internal modem.

A remotely located peripheral device is a peripheral device 108, 110, 112 that is not attached to the host PC 100. As used herein, the two are often used interchangeably.

Remoting Interface

A remoting interface is a device signal used by a remotely located peripheral device. On the device adaptor box, the remoting interface can be translated into a network stream for transmission to the PC adaptor box, or transmitted to a peripheral device connector for use by the remotely located peripheral device. On the PC adaptor box, the remoting interface is translated into a network stream for transmission to the device adaptor box, or transmitted to a peripheral device virtual control module for use by the host PC.

Network

A network 114 as used herein may mean either a wired network or a wireless network 114 in which software may be transmitted or received by the network interface device 222 of the host PC 100.

Adaptor Box

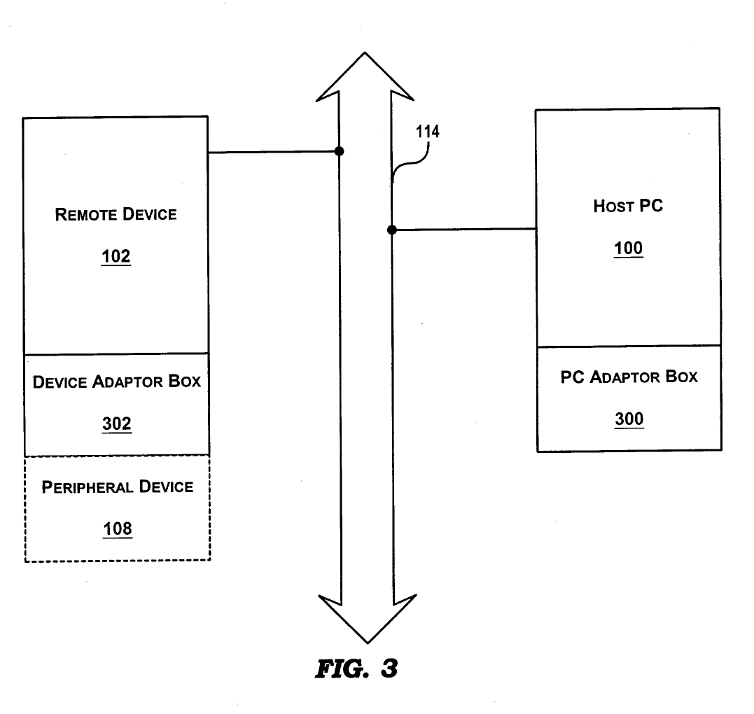

To enable remoting, an adaptor box is utilized on the remote device 102 (only one shown) and on the host PC 100, as illustrated in FIG. 3. Generally, the device adaptor box 302 and the PC adaptor box 300 may be a physical add-in box having both hardware and software componentry to support remoting of peripheral devices 108, 110, 112, or a conceptual box made up of software to support remoting of peripheral devices 108 (only one shown).

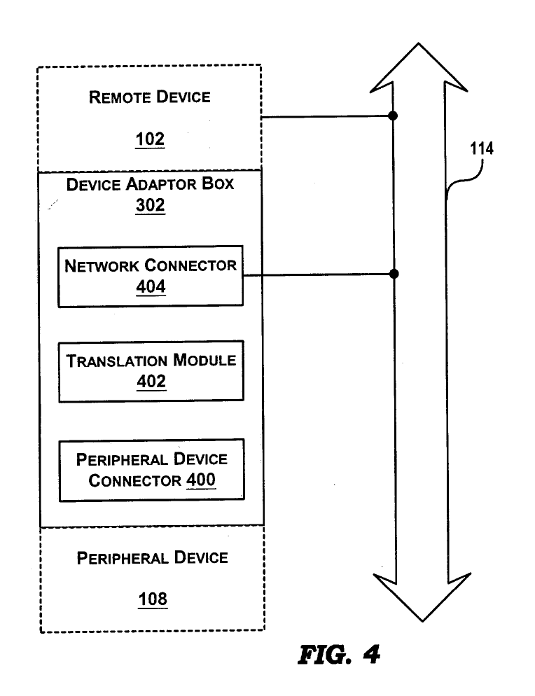

As illustrated in FIG. 4, the device adaptor box 302 allows a remote device to use a remotely located peripheral device 108. The device adaptor box 302 comprises at least one peripheral device connector 400 to establish connectivity between a peripheral device 108 and the network 114 on which the remote device 102 and host PC 100 reside; a translation module 402 to convert peripheral standard interfaces into.a network stream, and vice versa; and a network connector 404 to enable transmission of the network stream to the network 114. Remote device 102, device adaptor box 302, and peripheral device 108 are illustrated as being communicatively coupled, and may be configured in various ways, such as those discussed herein. For example, device adaptor box 302 may communicate with remote device 102 via a physical connector (not shown), or via network connector 404.

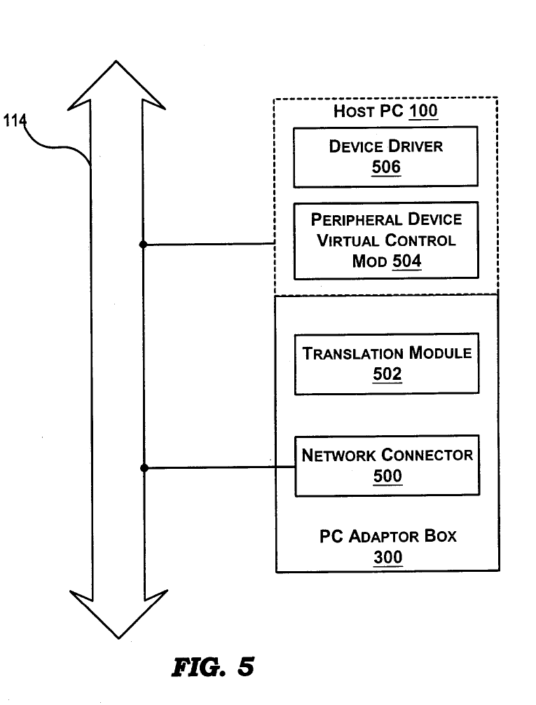

As illustrated in FIG. 5, the PC adaptor box 300 facilitates communication between the device adaptor box 302 and the host PC 100. It comprises a network connector 500 to establish connectivity between the network on which a given remote device 102 and host PC 100 reside and the PC adaptor box 300; and a translation module 502 to translate a network stream into a standard interface, and vice versa. Host PC 100 and PC adaptor box 302, are illustrated as being communicatively coupled, and may be configured in various ways, such as those discussed herein. For example, host PC 100 and PC adaptor box may communicate via a physical connector (not shown), or via network connector 500.

Once the request is translated to a standard interface, the device is available for use by the operating system, and all users using the operating system. Therefore, the user of a remote device will have access to the remote peripheral device using standard operating system interfaces (e.g., Windows Explorer, file selection boxes, peripherals, etc.).

Remote Device Configurations

Referring back to FIG. 4, a device adaptor box 302 may be built into a peripheral device 108, 110, 112. Alternatively, a device adaptor box 302 may have either standard slide-in slots for disk drives (similar to existing IDE (Integrated Drive Electronics) or SCSI (Small Computer System Interface) device expansion boxes), or ports. Additionally, a device adaptor box may be multi-purpose having any combinations of IDE/SCSI/Firewire ports, serial ports, parallel ports, and USB (Universal Serial Bus) ports.

The device adaptor box 302 comprises a peripheral device connector 400, a translation module 402, and a network connector 404. The peripheral device connector 400 receives a peripheral device 108, and may comprise a port that connects a serial device or a USB device, for example, or an interface for communicating with a drive, for example. The translation module 402 converts the device signals, which are sent as a remoting interface, into a network stream that conforms to a network protocol, and the network connector 404 transmits the network stream to a network 114. The network protocol may comprise, for example, TCP/IP (Transmission Control Protocol/Internet Protocol). Of course, other Internet protocols may be used, such as UDP (User Datagram Protocol), or ICMP (Internet Control Message Protocol).

Host PC Configurations

Referring back to FIG. 5, a PC adaptor box 300 may be completely separate from the host PC 100, plugging into existing PC ports (USB, SCSI, Firewire, etc.) The PC adaptor box 300 may alternatively be built into the host PC 100 as a box that slides into a disk drive slot, where the standard interface is SCSI or IDE, for example. Alternatively, the PC adaptor box 300 may be completely implemented in software, using the existing network stack to perform the conversion from the network stream to a standard interface, and vice versa, and to communicate with an existing device drive stack (such as a disk drive software stack).

The PC adaptor box 300 comprises a network connector 500, and a translation module 502. The network connector 500 is connected to the network 114 to send and receive a network stream. The translation module 502 converts appropriate network streams (i.e., network streams that were converted from a device signal) to a standard interface, and vice versa.

The peripheral device virtual control module 504 is a virtual module (i.e., virtual IDE controller) on the host PC 100 that communicates with the peripheral device connector 400 (i.e., actual IDE controller) on the remote device 102. The peripheral device virtual control module 504 is illustrated as existing on the host PC 100, in which case the host PC 100 would require minor modification. It is contemplated that the peripheral device control module 504 may alternatively exist on the PC adaptor box 300.

The device driver 506 translates commands from the remote device 102 into a language that the peripheral device 108 understands, and transmits those commands in the peripheral device 108 language to the peripheral device connector 400 associated with the remote device 102.

Methods

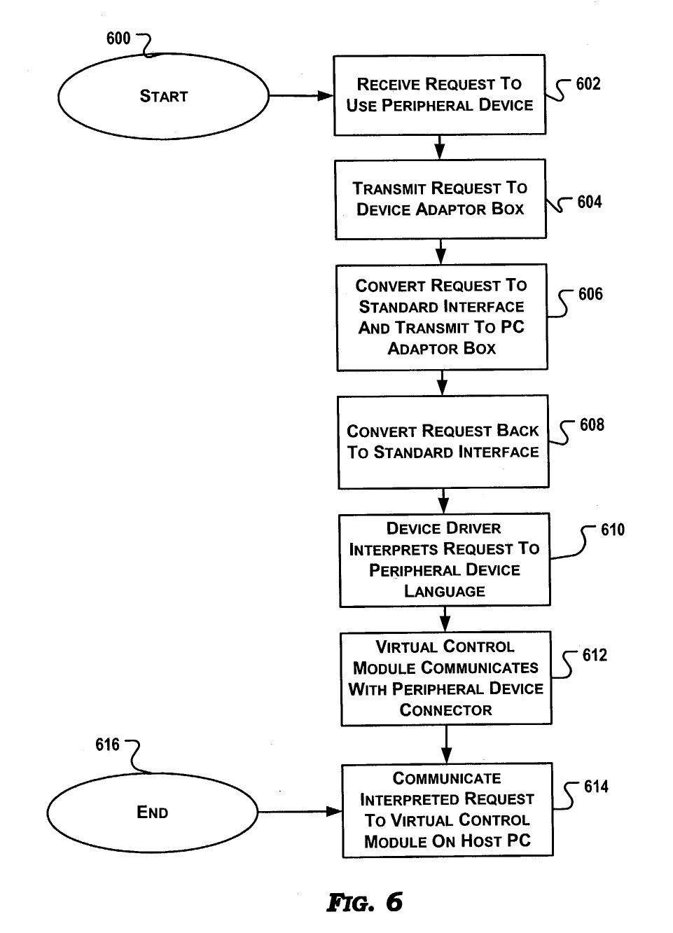

A method illustrating information transfer to and from a peripheral device within general embodiments of the invention is illustrated in FIG. 6. In the methods described, information may comprise a request, or data that is requested from the peripheral device or requested to be sent to the peripheral device.

In FIG. 6, which begins at block 600, a request to write data to, or retrieve data from a peripheral device is requested from a remote device at box 602. Since the remote device communicates with the host PC, and since the host PC believes the peripheral device to be local to it, the request is transmitted to the device adaptor box at box 604 (via TCP/IP, or a connector, for example), converted from a standard interface to a network stream and transmitted, via the network, to a PC adaptor box corresponding to the host PC to process the request at box 606. At the PC adaptor box, the request is intercepted by the network connector and converted back to a standard interface at box 608, where the device driver 506 interprets the request to a language appropriate to the requested peripheral device at box 610.

At box 612, the interpreted request is then communicated to a virtual control module corresponding to the peripheral device. The virtual control module then communicates with the actual peripheral device connector at box 614 to operate the peripheral device by sending back the interpreted request via the network, the network connector on device adaptor box, and the translation module on the device adaptor box. The method ends at block 616.

Where the request is a write to the peripheral device, the virtual control module communicates with the actual peripheral device connector at box 614 by sending back data for the peripheral device connector to store to the peripheral device. Where the request is for data from the peripheral device, the virtual control module communicates with the actual peripheral device connector at box 614 by sending the command associated with the request for the peripheral device connector to use. The requested data is then sent back to the host PC 100 via device adaptor box 302 and PC adaptor box 300 as described above.

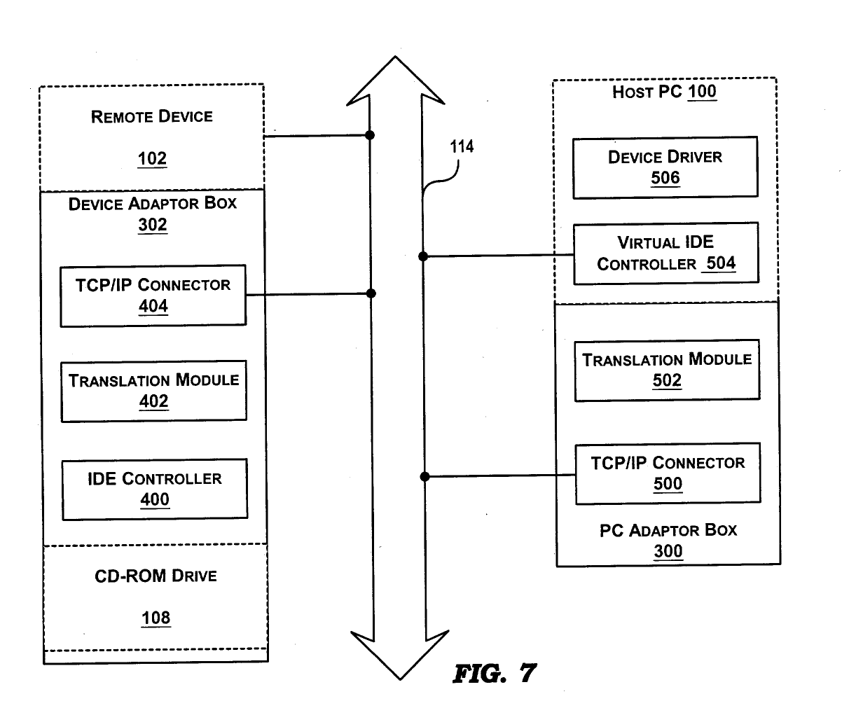

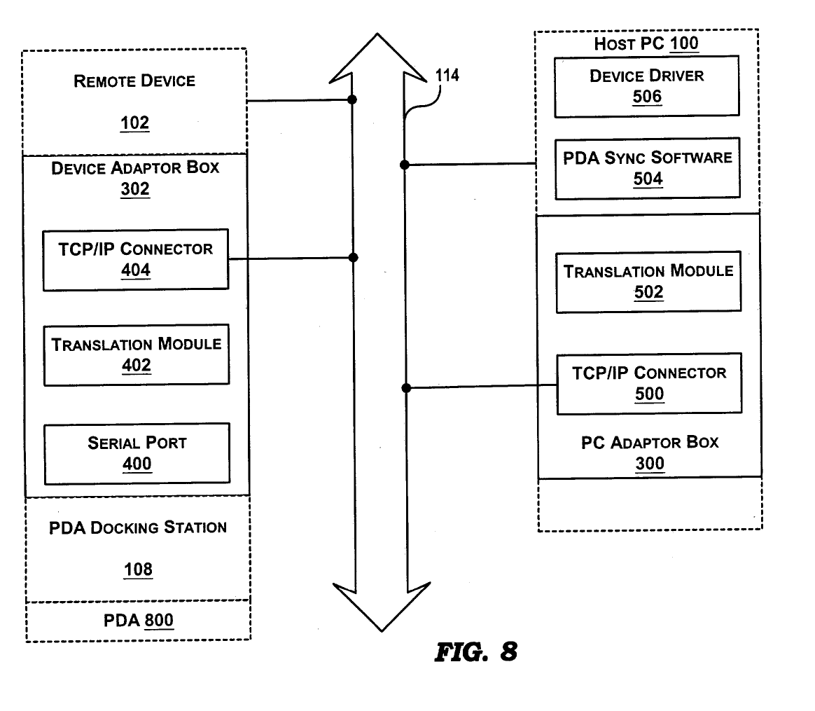

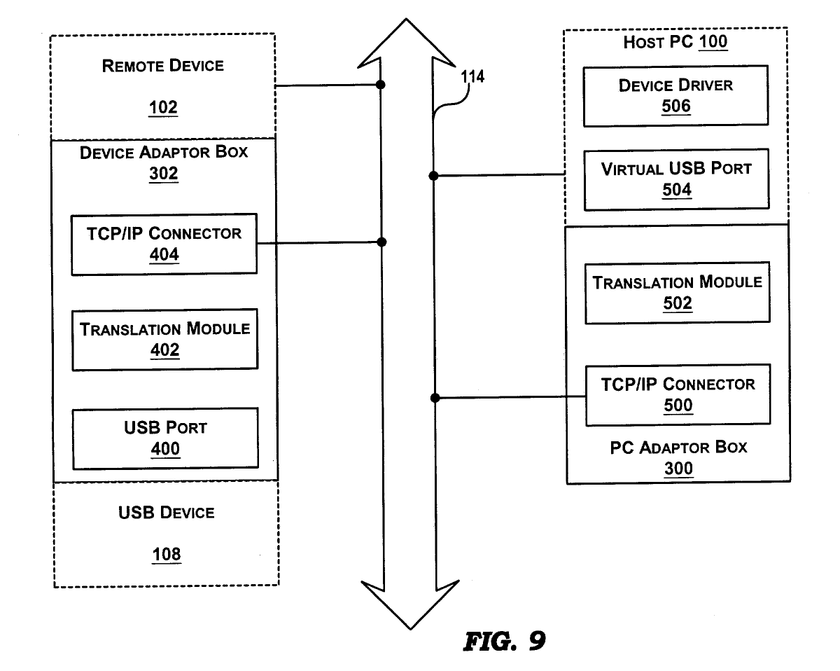

In the following exemplary embodiments, a remote device 102, host PC 100, device adaptor box 302, and PC adaptor box 300 are illustrated. In the first exemplary embodiment illustrated in FIG. 7, the device adaptor box 302 comprises a slide-in slot for a CD-ROM drive 108 using a standard IDE interface. In the second exemplary embodiment illustrated in FIG. 8, the device adaptor box 302 comprises a PDA docking station 108 using a USB standard interface. In the third exemplary embodiment illustrated in FIG. 9, the device adaptor box 302 comprises a USB device 108 using a USB standard interface. Each of these embodiments is described in more detail below.

First Exemplary Embodiment

In a first exemplary embodiment, as illustrated in FIG. 7, a peripheral device 108 comprises a CD-ROM drive 108 that slides into a slot of the device adaptor box 302. (Alternatively, the CD-ROM drive 108 may comprise the device adaptor box 302.) The CD-ROM drive allows CD-ROMs to be inserted therein, so that data may be read from it. (With another type of CD, such as a CD-R (Compact Disc-Recordable) or CD-RW (Compact Disc-rewriteable), data may also be written to the CD.)

Request to Use CD-ROM Drive

When a user requests to use a CD-ROM drive 108 from the remote device 102, the request is transmitted to the device adaptor box 302, converted to a TCP/IP transport format, and transmitted across the network 114 to the PC adaptor box 300. At the PC adaptor box 300, the request is received by TCP/IP connector 500, converted back to a standard interface by translation module 502, and communicated to the CD-ROM drive's 108 device driver 506 on the host PC 100. The device driver 506 communicates the request to the virtual IDE controller 504, which uses a standard IDE interface. The translation module 502 then converts the standard IDE interface to a network stream, which is then transferred over the network 114 via the TCP/IP connector 500.

Once the network stream is received on the remote device 102 via the TCP/IP connector 404, the translation module 402 converts the network stream back to an IDE interface, which is then used by the actual IDE controller 400. The IDE controller 400 can then operate the CD-ROM drive 108 as requested (i.e., reads a list of files available on the CD-ROM).

Data Transfer

The IDE controller 400 obtains the list of files from the CD-ROM via the CD-ROM drive 108. The translation module 402 converts the file list from an IDE interface to a network stream, which is then transmitted over the network 114 via the TCP/IP connector 404. On the PC adaptor box 300, the TCP/IP connector 500 receives the file list, and the translation module 502 converts the file list from a network stream to an IDE interface. The IDE interface may then be used by the virtual IDE controller 504, where it is available for use by the operating system.

As one of ordinary skill in the art would understand, peripheral device 108 in this embodiment may be any kind of disk storage device, such as a floppy disk drive. Furthermore, the controller may be other than an IDE controller; for example, it may be a SCSI controller, and peripheral device 108 in this embodiment may further be any type of device that may use an IDE controller, SCSI controller, or the like. Of course, these examples are not exhaustive, and should not be construed as limitations on embodiments of the invention.

Second Exemplary Embodiment

In a second exemplary embodiment, as illustrated in FIG. 8, a peripheral device 108 comprises a PDA docking station. The docking station 108 receives a PDA 800, and allows a remote device 102 to synchronize its calendar with a PDA 800, for example.

Request to Use the PDA

When a PDA 800 is docked to the PDA docking station 108, a user may request to synchronize the calendar on a PDA 800 with a calendar on the host PC 100, and request to synchronize the host PC calendar with the PDA calendar. The request is converted to a TCP/IP transport format, and transmitted across the network 114 to the PC adaptor box 300. At the PC adaptor box 300, the request is converted back to a standard interface, and communicated to the PDA docking station's 108 device driver 506. The device driver 506 communicates the request to the PDA synchronization software 504, which uses a standard serial interface. The translation module 502 then converts the standard serial interface to a network stream, which is then transferred over the network 114 to the device adaptor box 302 via the TCP/IP connector 500. At the device adaptor box 302, the request is converted back to a serial interface so that the serial port 400 can communicate the request to the PDA 800 via the PDA docking station 108.

Data Transfer

Where the request is for synchronizing the host PC 100 with the PDA 800, the PDA docking station 108 obtains the data from the PDA 800, the data is converted to a TCP/IP transport format, and transmitted across the network 114 to the PC adaptor box 300. At the PC adaptor box 300, the data is converted back to a serial interface which can then be used by the PDA synchronizing software 504.

Where the request is for synchronizing the PDA 800 with the host PC 100, PDA synchronization software 504 receives the request, and obtains the data from the host PC 100. The data is converted to a TCP/IP transport format, and transmitted over the network 114 to the device adaptor box 302, where it is converted back to a serial interface, and available at the serial port 400 for the PDA docking station 108.

In the example illustrated and described, PDA docking station 108 is connected to a serial port. However, as one of ordinary skill in the art would understand, port may be serial, USB, Bluetooth wireless, or infrared, for example (each using appropriate interfaces, etc.), without departing from the spirit and scope of embodiments of the invention.

Third Exemplary Embodiment

In a third exemplary embodiment, as illustrated in FIG. 9, a peripheral device 108 comprises a USB device (i.e., flash memory, camera, etc.).

Request to Use CD-ROM Drive

When a user requests the use of a USB device 108 from the remote device 102, the request is converted to a TCP/IP transport format, and transmitted across the network 114 to the PC adaptor box 300. At the PC adaptor box 300, the request is communicated to the USB device's 108 device driver 506 on the host PC 100 (after conversion by translation module 502). The device driver 506 communicates the request to the virtual USB port 504, which uses a standard USB interface. The translation module 502 then converts the standard USB interface to a network stream, which is then transferred over the network 114 via the TCP/IP connector 500.

Once the network stream is received on the device adaptor box 302 via the TCP/IP connector 404, the translation module 402 converts the network stream back to a USB interface, which is then used by the actual USB port 400. The USB port 400 can then operate the USB device 108 as requested.

Data Transfer

The USB port 400 performs the requested operation. For example, where the USB device 108 is flash memory, the user may request the transfer of one or more files. The translation module 402 converts the files from a USB interface to a network stream, which is then transmitted over the network 114 via the TCP/IP connector 404. On the PC adaptor box 300, the TCP/IP connector 500 receives the files, and the translation module 502 converts the files from a network stream to a USB interface. The USB interface may then be used by the virtual USB port 504, where it is available for use by the operating system.

Conclusion

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method comprising:
retrieving data from a remotely located peripheral device, the data including a standard interface, the data to be transmitted to a host PC (personal computer) and remoted to a remote device, and the remote device communicatively coupled to the host PC over a network, said retrieving performed by a device adaptor box associated with the remote device;
formatting the data on the device adaptor box;
transmitting the data over the network to a PC adaptor box associated with the host PC;
formatting the data on the PC adaptor box; and
transmitting the data to the host PC.

2. The method of claim 1, wherein:
said retrieving data comprises a peripheral device connector retrieving the data;
said formatting on the device adaptor box comprises translating the standard interface data into a network stream data;
said transmitting the data to the PC adaptor box comprises transmitting the data in a network stream to the network;
said formatting on the PC adaptor box comprises translating the network stream into a standard interface; and
said transmitting the data to the host PC comprises transmitting the standard interface to a peripheral device virtual control module of the host PC.

3. The method of claim 1, said retrieving, formatting, transmitting, and formatting in response to receiving a request from the remote device to retrieve information from the remotely located peripheral device, and:
the request including a standard interface that is translated into a network stream;
the network stream being transferred over the network to the PC adaptor box;
the network stream being converted back to the standard interface;
the standard interface being read by a device driver corresponding to the remotely located peripheral device, communicated to a peripheral device virtual control module, and networked to a peripheral device connector associated with the remotely located peripheral device over the network.

4. The method of claim 2, wherein the remotely located peripheral device comprises a disk storage device, the standard interface comprises an IDE (Integrated Device Electronics) interface, the peripheral device connector comprises an IDE controller, and the peripheral device virtual control module comprises a virtual IDE controller corresponding to the IDE controller.

5. The method of claim 1, wherein the network comprises a wired network.

6. The method of claim 1, wherein the network comprises a wireless network.

7. The method of claim 1, additionally comprising:
retrieving data from the host PC, the data including a standard interface, and the data to be transmitted to the remotely located peripheral device;
transmitting the data to the PC adaptor box for formatting;
formatting the data on the PC adaptor box;
transmitting the data over the network to the device adaptor box;
formatting the data on the device adaptor box; and
transmitting the data to the remotely located peripheral device.

8. The method of claim 7, wherein:
said transmitting comprises transmitting via a peripheral device virtual control module;
said formatting on the PC adaptor box comprises converting the standard interface data into a network stream;
said transmitting the data to the device adaptor box comprises transmitting the data in a network stream to the network;
said formatting the data on the device adaptor box comprises converting the network stream into a standard interface; and
said transmitting the data to the remotely located peripheral device comprises transmitting the data to a peripheral device connector of the remotely located peripheral device.

9. The method of claim 7, said retrieving, transmitting, formatting, transmitting, formatting, and transmitting in response to receiving a request from the remote device to send information to the remotely located peripheral device, and:
the request including a standard interface that is translated into a network stream;
the network stream being transferred over the network to the PC adaptor box;
the network stream being converted back to the standard interface;
the standard interface being read by a device driver corresponding to the remotely located peripheral device, communicated to the peripheral device virtual control module, and networked to a peripheral device connector associated with the remotely located peripheral device over the network.

10. The method of claim 9, wherein the network comprises a wireless network.

11. An apparatus comprising:
a peripheral device connector to receive a peripheral device remotely located from a remote device communicatively coupled to a host PC (personal computer) over a network, the connector being associated with a standard interface;
a translation module coupled to the peripheral device connector to convert the standard interface to a network stream, and to convert a network stream to the standard interface; and
a first network connector coupled to the translation module and to a network to transmit a converted network stream to a PC adaptor box corresponding to a host PC (personal computer), and to receive a network stream from the PC adaptor box.

12. The apparatus of claim 11, wherein the first network connector is additionally coupled to the remote device.

13. The apparatus of claim 11, wherein the peripheral device connector comprises a port.

14. The apparatus of claim 13, wherein the port comprises a serial port for receiving a docking station.

15. The apparatus of claim 13, wherein the port comprises a hub for receiving a USB (Universal Serial Bus) connector.

16. The apparatus of claim 11, wherein the peripheral device connector comprises a controller.

17. The apparatus of claim 16, wherein the interface comprises an IDE (Integrated Drive Electronics) controller.

18. The apparatus of claim 11, additionally comprising:
a second network connector coupled to a network to transmit a network stream to a device adaptor box corresponding to a remotely located peripheral device, and to receive a network stream from the device adaptor box; and
a translation module coupled to the network connector to receive the network stream, and convert the network stream to a standard interface, and to receive a standard interface, and to convert the standard interface to a network stream.

19. The apparatus of claim 11, wherein the network stream comprises data formatted using TCP/IP (Transmission Control Protocol/Internet Protocol).

20. A system comprising:
a device adaptor box corresponding to at least one remote device connected to a host PC (personal computer) on a network, the adaptor box having:
a peripheral device connector to receive a peripheral device remotely located from a remote device communicatively coupled to a host PC (personal computer) over a network, the connector being associated with a standard interface;
a first translation module coupled to the peripheral device connector to convert the standard interface to a network stream, and to convert a network stream to the standard interface; and
a first TCP/IP (Transmission Control Protocol/Internet Protocol) connector coupled to the translation module and to a network to transmit a converted network stream to a PC adaptor box corresponding to a host PC (personal computer), and to receive a network stream from the PC adaptor box; and
a PC adaptor box corresponding to the host PC, the adaptor box having:
a second TCP/IP connector coupled to a network to transmit a network stream to a device adaptor box corresponding to a remotely located peripheral device, and to receive a network stream from the device adaptor box; and
a second translation module coupled to the TCP/IP connector to receive the network stream, and convert the network stream to a standard interface, and to receive a standard interface, and to convert the standard interface to a network stream.

21. The system of claim 20, wherein the peripheral device connector comprises a port.

22. The system of claim 20, wherein the peripheral device connector comprises a controller.

23. The system of claim 22, wherein the interface comprises an IDE (Integrated Drive Electronics) controller.

24. A system comprising:
a remote device connected to a host PC (personal computer) on a network;
a device adaptor box corresponding to at least one remote device connected to a host PC (personal computer) on a network, the adaptor box having:
a peripheral device connector to receive a peripheral device remotely located from a remote device communicatively coupled to a host PC (personal computer) over a network, the connector being associated with a standard interface;
a first translation module coupled to the peripheral device connector to convert the standard interface to a network stream, and to convert a network stream to the standard interface; and
a first TCP/IP (Transmission Control Protocol/Internet Protocol) connector coupled to the translation module and to a network to transmit a converted network stream to a PC adaptor box corresponding to a host PC (personal computer), and to receive a network stream from the PC adaptor box
a PC adaptor box corresponding to the host PC, the adaptor box having:
a second TCP/IP connector coupled to a network to transmit a network stream to a device adaptor box corresponding to a remotely located peripheral device, and to receive a network stream from the device adaptor box; and
a second translation module coupled to the TCP/IP connector to receive the network stream, and convert the network stream to a standard interface, and to receive a standard interface, and to convert the standard interface to a network stream.

25. The system of claim 24, wherein the peripheral device connector comprises a port.

26. The system of claim 24, wherein the peripheral device connector comprises a controller.

27. A machine-readable medium having stored thereon data representing sequences of instructions, the sequences of instructions which, when executed by a processor, cause the processor to perform the following:
retrieve data from a remotely located peripheral device, the data including a standard interface, the data to be transmitted to a host PC (personal computer) and remoted to a remote device, and the remote device communicatively coupled to the host PC over a network, said retrieving performed by a device adaptor box associated with the remote device;
format the data on the device adaptor box;
transmit the data over the network to a PC adaptor box associated with the host PC;
format the data on the PC adaptor box;
transmit the data to the host PC;
retrieve data from the host PC, the data including a standard interface, and the data to be transmitted to the remotely located peripheral device;
transmit the data to the PC adaptor box for formatting;
format the data on the PC adaptor box;
transmit the data over the network to the device adaptor box;
format the data on the device adaptor box; and
transmit the data to the remotely located peripheral device.

28. The machine-readable medium of claim 27, wherein the remotely located peripheral device comprises a disk storage device, the standard interface comprises an IDE (Integrated Device Electronics) interface, the peripheral device connector comprises an IDE controller, and the peripheral device virtual control module comprises a virtual IDE controller corresponding to the IDE controller.

29. The machine-readable medium of claim 27, wherein the network comprises a wireless network.

30. The machine-readable medium of claim 27, wherein:
said retrieving data comprises a peripheral device connector to retrieve the data;
said formatting on the device adaptor box comprises translating the standard interface data into a network stream data;
said transmitting the data to the PC adaptor box comprises transmitting the data in a network stream to the network;
said formatting on the PC adaptor box comprises translating the network stream into a standard interface;
said transmitting the data to the host PC comprises transmitting the standard interface to a peripheral device virtual control module of the host PC;
said transmitting comprises transmitting via a peripheral device virtual control module;
said formatting on the PC adaptor box comprises converting the standard interface data into a network stream;
said transmitting the data to the device adaptor box comprises transmitting the data in a network stream to the network;
said formatting the data on the device adaptor box comprises converting the network stream into a standard interface; and
said transmitting the data to the remotely located peripheral device comprises transmitting the data to a peripheral device connector of the remotely located peripheral device.
